(19) United States
(12) Patent Application Publication
(10) Pub. No.: US 2008/0010466 A1
(43) Pub. Date: Jan. 10, 2008

(54) Digital identifier chaining

(76) Inventor: William Hopper, Kensington (AU)

Correspondence Address: John L. Sotomayor, Suite 300, 511 Davis Drive, Morrisville, NC, 27560, US

(21) Appl. No.: 11/482,943

(22) Filed: Jul. 10, 2006

(51) Int. Cl. H04L 9/00; G06F 12/14; H04L 9/32; G06F 11/30

(52) U.S. Cl. 713/187; 713/181

(57) ABSTRACT

This invention provides a means for insuring data security and confidence in a recorded sequence of data that includes video, audio and meta-data through the use of digital signatures. The digital signatures are calculated through the use of publicly available hash algorithms and chained in a new and novel manner to provide for confidence in the data integrity and security of the recorded data upon replay.

### TECHNICAL FIELD

The present invention is directed to a mobile digital video recording system and the recordation of an integrated audio, video and meta-data stream. In particular, the present invention is directed to a method and system for securing the authentication of video data recorded, and ensuring the integrity of the video record.

### BACKGROUND

The use of a recorded video stream for evidentiary purposes is enhanced if the recorded stream is demonstrably complete and each video frame can be shown to exist in proper order thus ensuring the integrity of the video record on a frame-by-frame basis. Present systems for recording and storing digital video data within a mobile environment, such as a public transport vehicle, do not provide the means for authenticating and ensuring the integrity of a digitally recorded video stream on a frame-by-frame basis.

The present invention addresses this issue with a novel method and system for attaching a unique digital identifier to each frame and associating the digital identifiers with one another so as to chain them together and ensure the integrity of the entire recorded video sequence on a frame-by-frame basis. Another advantage of this invention is that the digital identifier and association is generated as the video data is recorded, thus removing the need for a multi-step process and providing greater assurance that the video stream recorded retains its data integrity.

### SUMMARY OF THE INVENTION

This invention is directed to a mobile digital video recording system installed within a public transportation vehicle and that records an integrated data stream consisting of video, audio and meta-data. The video recordation task is enhanced in the instant invention to include a digital identifier within each frame of the video record.

The digital identifier is constructed during video capture. Each pixel of the captured image data initial frame is passed through a hash algorithm. The resulting hash value is appended to frame two. The hash value from frame 1 and the captured image data from frame two is the passed through the same hash algorithm. The process builds an entire video sequence of images in which n frame includes the hash algorithm value from frame n×1. This process continues for each frame in the captured video sequence.

When completed, each frame in the video sequence will contain the embedded hash value from the previous video frame. In this manner, data security is ensured through the chaining together of each video frame via the embedded hash values within each frame. In addition, if the replay of the video sequence is interrupted the replay may be restarted from the interruption point by starting from the last missing frame location within the chained sequence of frames.

### BRIEF DESCRIPTION OF THE DRAWINGS

FIG. 1: Process flow

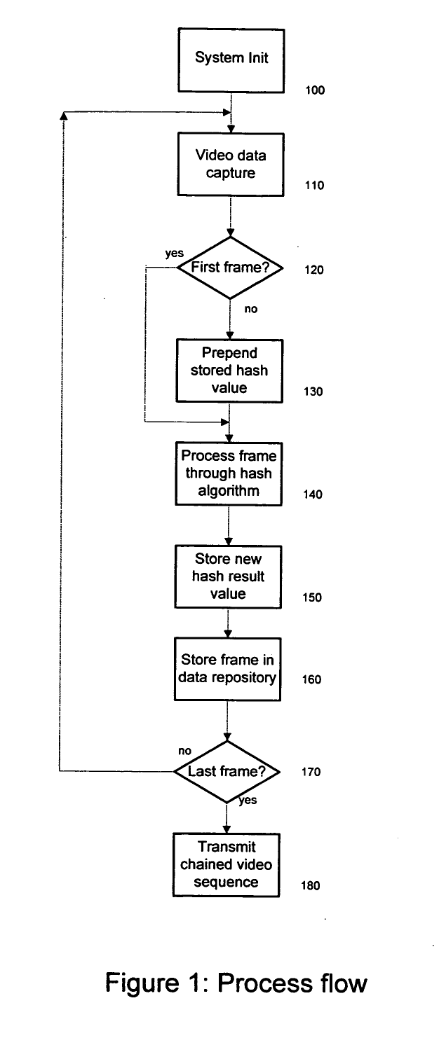

FIG. 2: System view

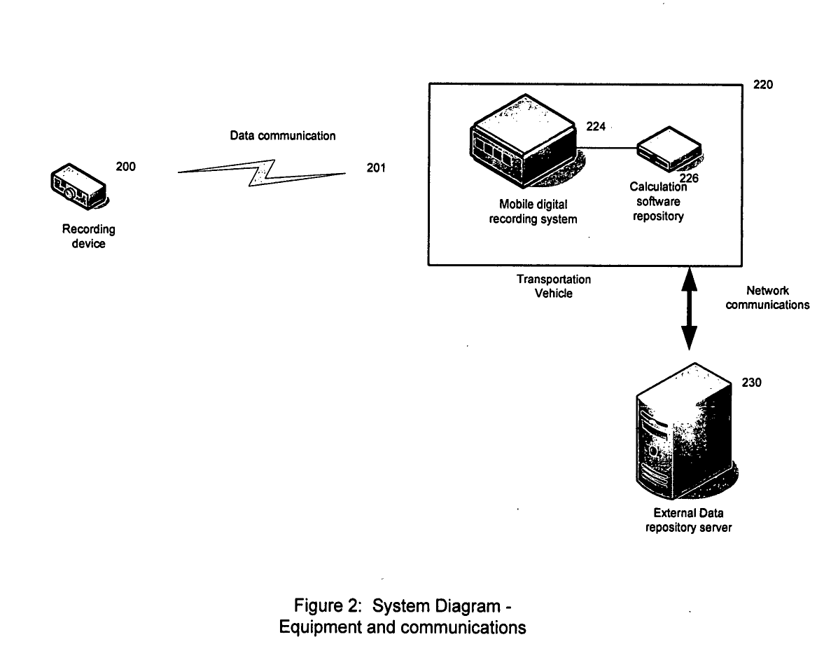

FIG. 3: Hash value chain generation

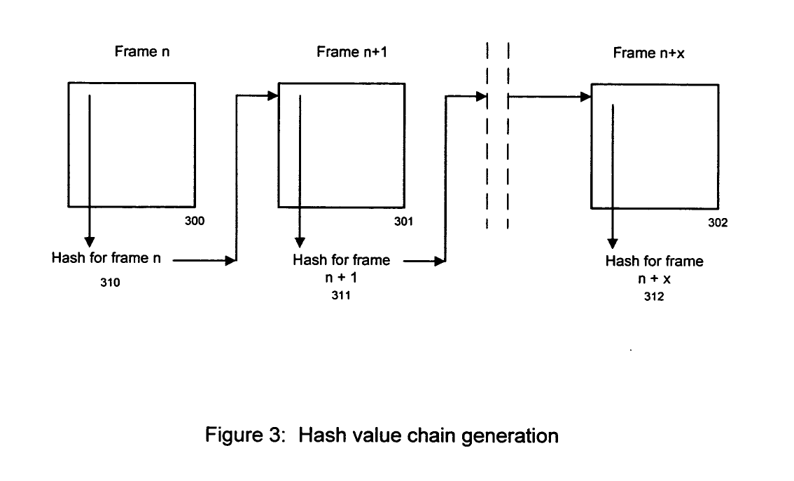

### DETAILED DESCRIPTION OF THE INVENTION

The present invention is a system and method that may be use in conjunction with a system that records and stores and integrated data stream of video, audio, and meta-data from within and surrounding a public transportation vehicle. The installed system addresses issues of security and liability for said transportation vehicle, and the instant invention may be appended to provide confidence in the data security of all records captured by the digital recorder system within the vehicle. The method of the instant invention uses any one of a number of publicly available hash algorithms to process the incoming recorded data and provide a reliable chain of connection within the data being recorded.

Hash algorithms are well known in the art and a number of them are freely available for use within other systems. Hash algorithms used in security systems provide for a recognizable digital signature that may be later used within a data check cycle to verify the integrity of the data. However, this check, by itself, does not ensure data security in any sequence of data, from frame to frame or data file to data file. The instant invention provides such assurance in a novel and non-obvious manner by computing a digital signature through the use of a hash algorithm for each frame of recorded data 140, appending the digital signature for a prior frame of data to a subsequent data frame 130, then computing a digital signature once again with said hash algorithm for the subsequent data frame and appended prior frame digital signature combined 140. In this manner, all the frames of data within a recorded sequence are chained together through the included hash values of prior frames of data 160.

In the preferred embodiment, a digital recording system is installed within a public transportation vehicle such as a police cruiser, subway train car, bus, or rail system train car 220. The system records an integrated stream of data comprising digitized video, audio, and meta-data in discrete frames 110. The frame rate is set prior to initialization of the system and may be any value from 1 to 30 frames per second. As each frame is captured and recorded, the instant invention, composed of a set of computer program modules, processes each frame through a hash algorithm 140. The hash algorithm may be any of a number of publicly available hash algorithms (such as the rotating, Universal, Generalized, or MD4 hash algorithm). As the hash algorithm completes the digital signature for a frame, the digital signature value is stored until the next frame start 150. As the next frame starts, the instant invention prepends the stored digital signature value to the incoming data stream 130 and begins the process of computing the digital signature for the next frame 140. When this frame is finished, the ensuing digital signature will have the digital signature value from the previous frame embedded within the digital signature for the current frame.

This process continues for the next and all subsequent frames until all frames except frame 1 contain the digital signature in which the hash value for frame n−1 310 is embedded within the hash value for frame n 311. In this manner, there is a continuous trace through the data sequence as represented by the embedded digital signatures that may be used to trace data origin and validity, thus ensuring data integrity for the entire recorded data sequence of frames. No frame can be dropped without a receiving system knowing that there is a missing frame and where within the sequence that missing frame occurred.

Utilizing this system, a single missing frame does not impair replay of the data sequence. Data replay may be restarted from the missing frame location by backtracking along the chained digital signatures and relocating the missing data.

While this invention has been particularly shown and described with reference to preferred embodiments thereof, it will be understood by those skilled in the art that various changes in form and details may be made therein without departing from the spirit and scope of the invention as defined by the appended claims.

We claim:

1. A system for securing data integrity and security of an integrated digital data stream recorded within and around a public vehicle platform comprising:
a means for capturing an integrated digital data stream;
means for processing said integrated digital data stream to calculate a unique value associated with frame n of said integrated digital data stream;
means for storing said unique value;
means for attaching said unique value representing the value for frame n to frame n+1 of said captured integrated digital data stream;
means for processing frame n+1 and said attached unique value of frame n of said integrated digital data stream to calculate a unique value associated with frame n+1 and said attached unique value of frame n;
wherein each attached unique value contains a previously calculated unique value such that each frame of said integrated digital data stream is chained together by said calculated unique values to secure data integrity of said integrated digital data stream.

2. A system as recited in claim 1 for securing data integrity and security of an integrated digital data stream recorded within and around a public vehicle platform further comprising:
wherein said integrated digital data stream comprises audio data, video data, meta-data, and analytic data.

3. A system as recited in claim 1 for securing data integrity and security of an integrated digital data stream recorded within and around a public vehicle platform further comprising:
wherein said integrated digital data stream is acquired by a digital recording system installed within said public vehicle platform.

4. A system as recited in claim 1 for securing data integrity and security of an integrated digital data stream recorded within and around a public vehicle platform further comprising:
wherein said calculated unique value is calculated by use of a software module containing an expression of any available hash algorithm.

5. A system as recited in claim 1 for securing data integrity and security of an integrated digital data stream recorded within and around a public vehicle platform further comprising:
wherein said storing means comprises at least one electronic memory storage device in data communication with said digital recording system and installed within said public vehicle platform.

6. A system as recited in claim 1 for securing data integrity and security of an integrated digital data stream recorded within and around a public vehicle platform further comprising:
wherein said digital recording system is also configured for wired and/or wireless data communication with a storage facility located remotely from said public vehicle platform.

7. A method for securing data integrity and security of an integrated digital data stream recorded within and around a public vehicle platform comprising the following steps:
a) a means for capturing an integrated digital data stream;
b) means for processing said integrated digital data stream to calculate a unique value associated with frame n of said integrated digital data stream;
c) means for storing said unique value;
d) means for attaching said unique value representing the value for frame n to frame n+1 of said captured integrated digital data stream;
e) means for processing frame n+1 and said attached unique value of frame n of said integrated digital data stream to calculate a unique value associated with frame n+1 and said attached unique value of frame n;
f) repeating steps b-e until all frames of a captured integrated digital data stream are processed;
g) wherein each attached unique value contains a previously calculated unique value such that each frame of said integrated digital data stream is chained together by said calculated unique values to secure data integrity of said integrated digital data stream.

8. A method as recited in claim 7 for securing data integrity and security of an integrated digital data stream recorded within and around a public vehicle platform further comprising the step of:
wherein said integrated digital data stream comprises audio data, video data, meta-data, and analytic data.

9. A method as recited in claim 7 for securing data integrity and security of an integrated digital data stream recorded within and around a public vehicle platform further comprising the step of:
acquiring said integrated digital data stream through a digital recording system installed within said public vehicle platform.

10. A method as recited in claim 7 for securing data integrity and security of an integrated digital data stream recorded within and around a public vehicle platform further comprising the step of:
calculating said calculated unique value by use of a software module containing an expression of any available hash algorithm.

11. A method as recited in claim 7 for securing data integrity and security of an integrated digital data stream recorded within and around a public vehicle platform further comprising the step of:
storing said chained integrated digital data stream within at least one electronic memory storage device in data communication with said digital recording system and installed within said public vehicle platform.

12. A method as recited in claim 7 for securing data integrity and security of an integrated digital data stream recorded within and around a public vehicle platform further comprising the step of:
communicating said chained integrated digital data stream with a storage facility located remotely from said public vehicle platform through wired or wireless means.
